(19) United States
(12) Patent Application Publication
(10) Pub. No.: US 2014/0109688 A1
(43) Pub. Date: Apr. 24, 2014

(54) ULTRASONIC FLOWMETER AND FLUID CONTROLLER HAVING THE SAME

(71) Applicant: ASAHI ORGANIC CHEMICALS INDUSTRY CO., LTD., Miyazaki (JP)

(72) Inventor: Hidenori EBIHARA, Miyazaki (JP)

(73) Assignee: ASAHI ORGANIC CHEMICALS INDUSTRY CO., LTD., Miyazaki (JP)

(21) Appl. No.: 14/061,109

(22) Filed: Oct. 23, 2013

(30) Foreign Application Priority Data
Oct. 24, 2012 (JP) 2012-234889

(51) Int. Cl. G01F 1/66

(52) U.S. Cl. CPC G01F 1/66
USPC 73/861.27

(57) ABSTRACT

An ultrasonic flowmeter includes a measurement pipe through which a fluid flows, and two ultrasonic transceivers mounted on two transmitting bodies, respectively. The transmitting bodies are provided on outer side portions of the measurement pipe so as to be spaced from each other in an axis direction, and the measurement pipe and the two transmitting bodies are formed integrally with each other. The measurement pipe has a length, an inner diameter uniform in a length direction, and an arithmetic mean roughness Ra of an inner peripheral surface. The inner diameter is equal to or less than 5 mm, and the length of the measurement pipe is equal to or more than 30 mm. The arithmetic mean roughness Ra satisfies a relation of 0 μm<Ra≦0.2 μm.

### CROSS-REFERENCE TO RELATED APPLICATIONS

This application is based on Japanese Patent Application No. 2012-234889, the contents of which are incorporated herein by reference.

### BACKGROUND OF THE INVENTION

1. Field of the Invention

The present invention relates to an ultrasonic flowmeter for use in fluid transportation in various industries such as chemical works, semiconductor manufacture field, food processing field and biotechnology field, which propagates an ultrasonic vibration through a fluid and measures a flow velocity or flow rate of the fluid from a difference between the ultrasonic wave propagation time from the upstream side of the flow and the ultrasonic wave propagation time from the downstream side of the flow, and also to a fluid controller having such an ultrasonic flowmeter. The present invention particularly relates to an ultrasonic flowmeter suitable for measuring a micro flow rate and the flow rate of a slurry fluid or especially the CMP slurry fluid used in the semiconductor field, and also to a fluid controller having such an ultrasonic flowmeter.

2. Description of the Related Art

Ultrasonic flowmeters for measuring a flow velocity or flow rate of a fluid flowing in a measurement pipe from a difference in ultrasonic wave propagation time are generally classified into two types.

In a first type of ultrasonic flowmeter, flow passages are connected to both ends of a liner measurement pipe so that the flow passages are at generally right angle to the measurement pipe, and ultrasonic transceivers are disposed on an upstream side and a downstream side of the measurement pipe so that the ultrasonic transceivers face each other across the measurement pipe. In the ultrasonic flowmeter, an ultrasonic wave transmitted from the upstream ultrasonic transceiver is propagated through a fluid in the measurement pipe and received by the downstream ultrasonic transceiver. Instantaneously after that, an ultrasonic wave transmitted from the downstream ultrasonic transceiver is propagated into the fluid in the measurement pipe and received by the upstream ultrasonic transceiver (see Japanese Unexamined Patent Publication Nos. 2000-146645, 2006-337059, 2007-58352, etc.). In the process, a difference between the ultrasonic wave propagation time from the upstream ultrasonic transceiver to the downstream ultrasonic transceiver and the ultrasonic wave propagation time from the downstream ultrasonic transceiver to the upstream ultrasonic transceiver is used to determine the flow velocity of the fluid in the measurement pipe and measure the flow rate.

In a second type of ultrasonic flowmeter, two ultrasonic transceivers are disposed on transmitting bodies mounted on outer peripheral portions of a liner measurement pipe, respectively. In the ultrasonic flowmeter, an ultrasonic wave transmitted from one of the ultrasonic transceivers is propagated into a fluid in the measurement pipe through the transmitting body and a wall of the measurement pipe, propagated obliquely with respect to a flowing direction of the fluid in the measurement pipe while being reflected on the pipe wall of the measurement pipe, and received by the other ultrasonic transceiver. Instantaneously after that, the transmitting side and the receiving side are switched, and, similarly to above, an ultrasonic wave transmitted from one of the ultrasonic transceivers is received by the other ultrasonic transceiver (see Japanese Unexamined Patent Publication Nos. 2005-188974, 2008-275607, 2011-112499, etc.). In the process, like the first type of the ultrasonic flowmeter, a difference between the ultrasonic wave propagation time from the upstream ultrasonic transceiver to the downstream ultrasonic transceiver and the ultrasonic wave propagation time from the downstream ultrasonic transceiver to the upstream ultrasonic transceiver is used to determine the flow velocity of the fluid in the measurement pipe and measure the flow rate.

In the first type of the ultrasonic flowmeter, bent portions are formed on both end portions of the measurement pipe. Therefore, especially in a case where a fluid flowing in the measurement pipe is a slurry, the slurry is deposited and fixed to the bent portions, and propagation of the ultrasonic vibration is hindered, thus causing a problem that accurate measurement of the flow rate is not possible. On the contrary, the second type of the ultrasonic flowmeter has an advantage that the above-mentioned problem is unlikely to be posed since it is not necessary to form bent portions on both end portions of the measurement pipe.

However, in the second type of the ultrasonic flowmeter, it is necessary to provide the transmitting bodies on the outer peripheral portion of the measurement pipe. In a case where the transmitting bodies fabricated in a process different from the measurement pipe fabricating process are later mounted to the measurement pipe by an adhesive, welding, etc., it is likely that positions of the transmitting bodies with respect to the measurement pipe and a distance between the transmission bodies vary depending on proficiency of an operator, thus causing deterioration of measurement accuracy. Further, factors such as an amount of adhesive applied, drying time of the adhesive, uniformity of application of the adhesive, etc., cause variation in performance of the ultrasonic flowmeter, and therefore need to be controlled in order to ensure performance of the ultrasonic flowmeter. In addition, in a case where a small-diameter measurement pipe is used, a problem occurs that it is difficult to assemble the measurement pipe and the transmitting bodies. It is not necessary to use an adhesive when the measurement pipe and the transmitting bodies are formed integrally with each other by injection molding. However, it is necessary to provide a draft in an inner diameter of the measurement pipe, which makes a flow velocity of a fluid in the measurement pipe non-constant. Therefore, forming the measurement pipe and the transmitting bodies integrally with each other is not suitable especially for fabricating a small-diameter measurement pipe. As a result, when fabricating the transmitting bodies and the measurement pipe integrally with each other, cutting work is often used.

However, with the cutting work, it is especially difficult to fabricate a measurement pipe having a small pipe diameter, and it is also difficult to control quality of an inner peripheral surface of the measurement pipe. Further, microasperity is formed on the inner peripheral surface of the measurement pipe, and microscopic bubbles are thus easily adhered to the inner peripheral surface of the measurement pipe. Surfaces of the microscopic bubbles reflect an ultrasonic vibration, thereby causing a decrease in output signal strength and deterioration of measurement accuracy especially in the second type of the ultrasonic flowmeter in which the ultrasonic vibration is propagated while being reflected within the measurement pipe.

In order to solve the problem of the microscopic bubbles inside the measurement pipe, Japanese Unexamined Patent Publication No. 2012-42243 suggests a straight-pipe type ultrasonic flowmeter in which, as shown in FIG. 8, a measurement portion 103 provided in a measurement space 102 of a housing 101 includes a straight pipe member 104 for measurement through which a fluid for measurement flows, and a pair of transducers 105 disposed on an outer periphery of the pipe member 104 at a given interval in an axial direction. A diameter-reduced portion or a bubble-crushing portion 106 is provided on a downstream side of the pipe member 104, thereby crushing small bubbles, which are generated when a flow rate is small and are likely to gather near an inner wall surface. However, a pressure drop is caused by the diameter-reduced portion provided as the bubble-crushing portion 106, and foreign matters are likely to be adhered to and deposited on the diameter-reduced portion. Further, it becomes difficult for regular-sized bubbles to pass through due to the diameter-reduced portion, which can cause deterioration of measurement accuracy.

### BRIEF SUMMARY OF THE INVENTION

Accordingly, it is an object of the present invention to solve the problems of the prior art and to provide an ultrasonic flowmeter in which transmitting bodies for ultrasonic transceivers to be mounted thereon are formed integrally with a measurement pipe and microscopic bubbles are unlikely to be adhered to an inner peripheral surface of the measurement pipe of the ultrasonic flowmeter.

In a first aspect, according to the present invention, there is provided an ultrasonic flowmeter including a measurement pipe through which a fluid flows, and two ultrasonic transceivers mounted on two transmitting bodies, respectively, the transmitting bodies being provided on outer side portions of the measurement pipe so as to be spaced apart from each other in an axis direction, the measurement pipe and the two transmitting bodies being formed integrally with each other, the ultrasonic flowmeter determining a flow velocity of the fluid by receiving an ultrasonic vibration transmitted from one of the two ultrasonic transceivers through the fluid in the measurement pipe with the other ultrasonic transceiver, alternately switching between the ultrasonic transceiver on the transmitting side and the ultrasonic transceiver on the receiving side, and measuring the ultrasonic wave propagation time between the two ultrasonic transceivers, wherein the measurement pipe has a length, an inner diameter uniform in a length direction, and an arithmetic mean roughness Ra of an inner peripheral surface, the inner diameter being equal to or less than 5 mm, the length of the measurement pipe being equal to or more than 30 mm, and the arithmetic mean roughness Ra satisfying a relation of 0 μm<Ra≦0.2 μm.

In the ultrasonic flowmeter having the measurement pipe and the transmitting bodies formed integrally with each other, when the measurement pipe has a length of 30 mm or more and an inner diameter of 5 mm or less being uniform in a length direction, it is difficult to fabricate the measurement pipe by injection molding, and a draft in an inner hole of the measurement pipe largely affects measurement accuracy. Therefore, the measurement pipe is generally fabricated by cutting work. In this case, a microasperity (having arithmetic mean roughness of approximately 0.4 μm) is formed on the inner peripheral surface of the measurement pipe, and microscopic bubbles are easily adhered to the microasperity on the inner peripheral surface of the measurement pipe. As a result, microscopic bubbles adhered to the inner peripheral surface of the measurement pipe adversely affects propagation of an ultrasonic wave, and causes signal strength reduction and deterioration of measurement accuracy. The present inventors have found the fact that the arithmetic mean roughness Ra of the inner peripheral surface satisfying the relation of 0μm<Ra≦0.2 μm makes it possible to prevent microscopic bubbles from being adhered to the inner periphery of the measurement pipe. By making the arithmetic mean roughness Ra of the inner peripheral surface of the measurement pipe satisfy the relation of 0 μm<Ra≦0.2 μm, an influence of microscopic bubbles on propagation of an ultrasonic vibration is suppressed to enhance signal strength of an output signal, and measurement accuracy is improved.

In the ultrasonic flowmeter, the arithmetic mean roughness Ra of the inner peripheral surface of the measurement pipe more preferably satisfies the relation of 0 μm<Ra≦0.02 μm. When the arithmetic mean roughness Ra of the inner peripheral surface of the measurement pipe is within the above range, adhesion of microscopic bubbles can be prevented more effectively.

Preferably, the measurement pipe and the transmitting bodies are made of a same kind of fluorine resin.

In a second aspect, according to the present invention, there is provided a fluid controller including the ultrasonic flowmeter described above, and a control part controlling an instrument in accordance with an output from the ultrasonic flowmeter.

In the ultrasonic flowmeter according to the present invention, the measurement pipe has the smooth inner peripheral surface and therefore it is unlikely that microscopic bubbles are adhered to the inner peripheral surface of the measurement pipe. This makes it possible to suppress an influence of microscopic bubbles on propagation of ultrasonic vibration, thereby improving measurement accuracy. As a result, an ultrasonic flowmeter with high measurement accuracy can be provided.

### BRIEF DESCRIPTION OF THE SEVERAL VIEWS OF THE DRAWING

The above and other objects, features and advantages of the present invention will be described below in more detail based on embodiments thereof with reference to the accompanying drawings, in which:

FIG. 1 is a longitudinal sectional view showing an overall configuration of an ultrasonic flowmeter according to the present invention;

FIG. 2 is an explanatory view showing a first example of a method for smoothing an inner peripheral surface of a measurement pipe of the ultrasonic flowmeter;

FIGS. 3A and 3B are explanatory views showing a second example of a method for smoothing the inner peripheral surface of the measurement pipe of the ultrasonic flowmeter;

FIGS. 4A and 4B are explanatory views for explaining an influence of microscopic bubbles adhered to the inner peripheral surface of the measurement pipe of the ultrasonic flowmeter;

FIG. 5 is a schematic view showing an overall configuration of experimental equipment for studying an influence of the surface roughness of the inner peripheral surface of the measurement pipe of the ultrasonic flowmeter on measurement accuracy and output signal strength;

FIGS. 6A and 6B are a table and a graph, respectively, showing results of amplitudes of signals received when surface roughness of the inner peripheral surface of the measurement pipe of the ultrasonic flowmeter is changed variously;

FIG. 7 is a diagram showing an overall configuration of a fluid controller in which the ultrasonic flowmeter according to the present invention is used; and

FIG. 8 is a partial cross-sectional side view showing an example of a conventional ultrasonic flowmeter.

### DETAILED DESCRIPTION OF THE INVENTION

While embodiments of an ultrasonic flowmeter according to the present invention and a fluid controller having such an ultrasonic flowmeter will be described with reference to the drawings, the present invention should not, of course, be limited thereto.

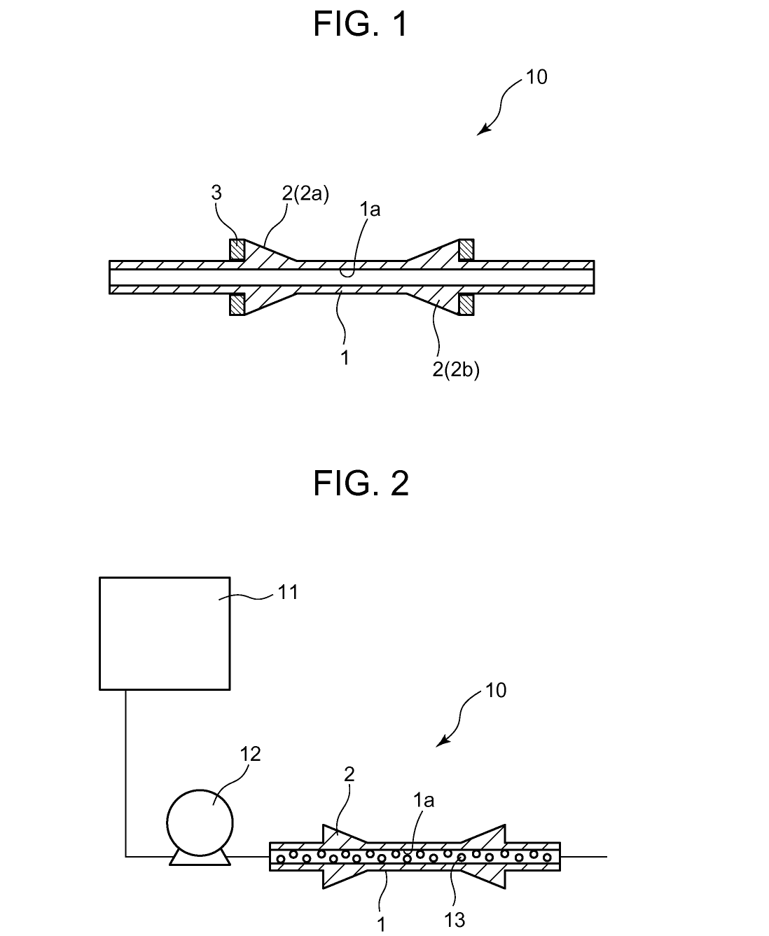

First, an overall configuration of an ultrasonic flowmeter 10 according to the present invention will be described with reference to FIG. 1.

The ultrasonic flowmeter 10 includes a measurement pipe 1 through which a fluid to be measured flows in a filled state, a pair of transmitting bodies 2 constituted by a first transmitting body 2a and a second transmitting body 2b, and ultrasonic transducers 3 serving as ultrasonic transceivers that are mounted on the pair of transmitting bodies 2, respectively.

A length of the measurement pipe 1 is equal to or more than 30 mm. An inner diameter of the measurement pipe 1 is uniform in a length direction and is equal to or less than 5 mm and uniform in a length direction. If such a measurement pipe 1 is fabricated by injection molding, a draft in an inner hole of the measurement pipe 1 changes flow velocity of a fluid flowing through the measurement pipe 1, and largely affects measurement accuracy. Further, there is a problem that it is difficult to design molds and control molding conditions. Therefore, such a measurement pipe 1 is generally fabricated by cutting work, thereby forming a microasperity (normally, arithmetic mean roughness Ra of 0.4 μm or more) on an inner peripheral surface 1a of the measurement pipe 1. As a result, microscopic bubbles are easily adhered to the inner peripheral surface 1a of the measurement pipe 1. In the ultrasonic flowmeter 10, the inner peripheral surface 1a of the measurement pipe 1 is smoothed more than a surface formed by cutting work so that microscopic bubbles are less likely to be adhered to the inner peripheral surface 1a of the measurement pipe 1. More specifically, methods such as polishing and melting described later are used so that arithmetic mean roughness Ra of the inner peripheral surface 1a of the measurement pipe 1 is within a range of 0 μm<Ra≦0.2 μm, more preferably, within a range of 0 μm<Ra≦0.02 μm.

Preferably, the measurement pipe 1 is made of a synthetic resin material such as perfluoroalkoxy fluorocarbon resin (PFA), polyvinylidene fluoride (PVDF), polyvinyl chloride (PVC) or polypropylene (PP), etc. However, the material for the measurement pipe 1 is not particularly limited as long as the measurement pipe 1 can propagate an ultrasonic wave, and the measurement pipe 1 may be made from metal such as duralumin, aluminum, aluminum alloy, titanium, hastelloy or stainless steel (SUS), glass, or quartz. An outer diameter of the measurement pipe 1 is not particularly limited. However, a thin pipe wall of the measurement pipe 1 is preferred in order to facilitate propagation of an ultrasonic vibration.

The first transmitting body 2a and the second transmitting body 2b of the pair of transmitting bodies 2 are provided on outer side portions of the measurement pipe 1 so as to be spaced apart from each other in an axis direction of the measurement pipe 1, and are formed integrally with the measurement pipe 1. Preferably, as in the embodiment shown in FIG. 1, each of the first transmitting body 2a and the second transmitting body 2b has a substantially conical shape, a diameter of which is increased towards a bottom face side from a cone point side, and inner peripheral surfaces of through holes of the first transmitting body 2a and the second transmitting body 2b, which surround a circumference of the measurement pipe 1, are entirely and integrally joined together with the outer peripheral surface of the measurement pipe 1. Further, the first transmitting body 2a and the second transmitting body 2b are disposed opposite to each other so that the cone point sides thereof are positioned closer to each other and the bottom face sides thereof are positioned farther from each other. On the bottom face sides of the first transmitting body 2a and the second transmitting body 2b, there are provided end faces extending in a direction perpendicular to the axis direction of the measurement pipe 1.

However, a shape of the transmitting body 2 is not limited to the shape described in the embodiment shown in FIG. 1. For example, in the embodiment shown in FIG. 1, each of the transmitting bodies 2 (the first transmitting body 2a and the second transmitting body 2b) has a substantially conical shape, and the inner peripheral surfaces of the through holes, which surround a circumference of the measurement pipe 1, are formed to be entirely integral with the outer peripheral surface of the measurement pipe 1. However, it is also possible that the diameter of the through hole on the bottom face side is increased so as to be larger than the diameter of the through hole on the cone point side and that only a part of the inner peripheral surface of each of the through holes on the cone point side thereof is integrally joined together with the outer peripheral surface of the measurement pipe 1 while the remaining part of the inner peripheral surfaces of the through holes are separated from the outer peripheral surface of the measurement pipe 1. In this case, it is preferred that at least one third of the inner peripheral surface of the through hole of each of the transmitting bodies 2 is integrally joined together with the outer peripheral of the measurement pipe 1 so that an ultrasonic wave is easily propagated to the measurement pipe 1 from each of the transmitting bodies 2.

A material for the transmitting bodies 2 is not particularly limited. For example, the transmitting bodies 2 may be made of a synthetic resin such as perfluoroalkoxy fluorocarbon resin (PFA), polyvinylidene fluoride (PVDF), polyvinyl chloride (PVC) or polypropylene (PP), or may be made of metal such as duralumin, aluminum, aluminum alloy, titanium, hastelloy or stainless steel (SUS), glass, quartz, and so on. However, the transmitting bodies 2 are preferably made of the same material as the measurement pipe 1 in order to realize good propagation capability of an ultrasonic vibration.

The ultrasonic transducers 3 used as ultrasonic transceivers are not particularly limited as long as the ultrasonic transducers 3 can generate ultrasonic waves. For example, the ultrasonic transducer 3 may be an ultrasonic transducer which is fabricated by using a piezoelectric material such as lead zirconate titanate (PZT) and generates an ultrasonic wave by extending and contracting in an axis direction when voltage is applied. The ultrasonic transducers 3 are mounted on the transmitting bodies 2, respectively, so that an ultrasonic wave generated by one of the ultrasonic transducers 3 is propagated to the other ultrasonic transducer 3 through a fluid in the measurement pipe 1. In the embodiment shown in FIG. 1, each of the ultrasonic transducers 3 has a doughnut shape or a shape of a disk with a hole, and the axial end faces of the ultrasonic transducers 3 are bonded to the end faces of the transmitting bodies 2 on the bottom face side, respectively, by an adhesive or the like. The inner diameter of the ultrasonic transducer 3 is substantially equal to the diameter of the through hole of each of the transmitting bodies 2 on the bottom face side, and an inner peripheral surface of the ultrasonic transducer 3 is separated from the outer peripheral surface of the measurement pipe 1. However, the shape of the ultrasonic transducer 3 is not limited to the shape of the disk with the hole, and may be, for example, a semicircular shape or a sector shape.

The inner peripheral surface 1a of the measurement pipe 1 may be smoothed by a method such as polishing and melting as described below.

FIG. 2 shows a first method for smoothing the inner peripheral surface 1a of the measurement pipe 1. According to the first method, the ultrasonic flowmeter 10, having the measurement pipe 1 and the transmitting bodies 2 formed to be integral with each other, is fabricated by cutting work, and then a slurry (for example, alumina slurry) containing slurry particles 13 is supplied and flown into the measurement pipe 1 of the ultrasonic flowmeter 10 from a slurry tank 11 by using a pump 12, thereby making the slurry particles 13 polish the inner peripheral surface 1a of the measurement pipe 1 so that an arithmetic mean roughness Ra of the inner peripheral surface 1a is within a range of 0 μm<Ra≦0.2 μm. Relatively large-sized slurry particles 13 may be used to perform the polishing first and then relatively small-sized slurry particles 13 may be used to perform the polishing. An experiment was conducted, where alumina slurry with a particle size of 0.4 μm was supplied into the measurement pipe 1 having an inner diameter of 2 mm and an outer diameter of 4 mm at a pressure of 380 kPa and a flow rate of 500 mL/minute for 20 days, to polish the inner peripheral surface 1a. As a result, the arithmetic mean roughness Ra of the inner peripheral surface 1a of the measurement pipe 1 became 0.2 μam. Output signals from the ultrasonic transducer 3 on the receiving side of the ultrasonic flowmeter 10 before and after the polishing were compared under the same conditions. As a result, a peak-to-peak voltage Vp-p of the output signal from the ultrasonic transducer 3 on the receiving side before the polishing was 41 mV, while the peak-to-peak voltage Vp-p of the output signal from the ultrasonic transducer 3 on the receiving side after the polishing was 226 mV. It was thus confirmed that strength of received signal was enhanced and that an influence of microscopic bubbles was reduced. An effect of improvement in measurement accuracy was also achieved.

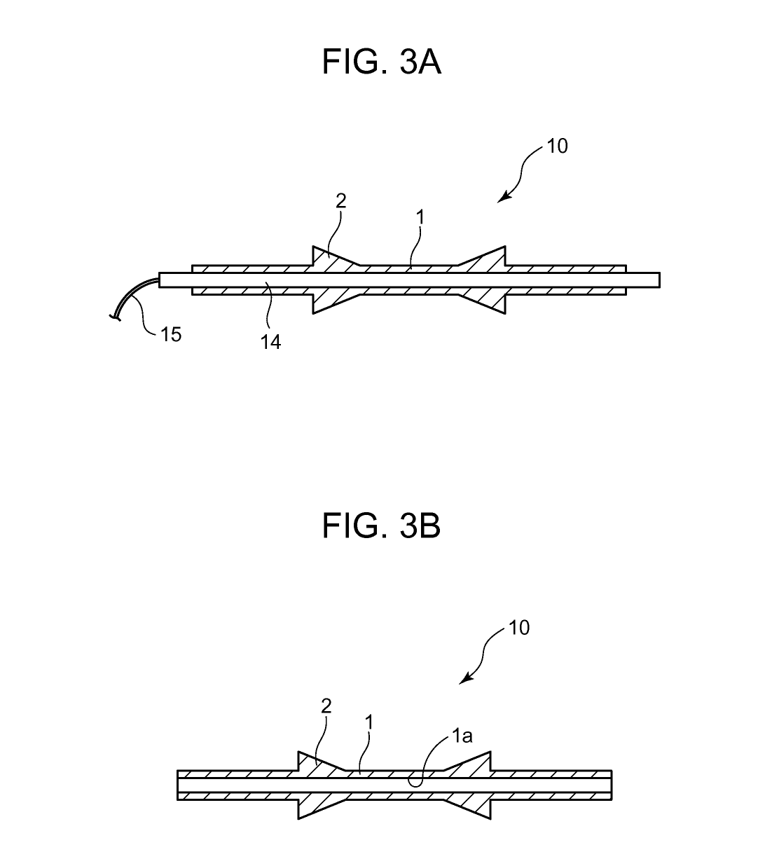

FIG. 3 shows a second method for smoothing the inner peripheral surface 1a of the measurement pipe 1. According to the second method, the ultrasonic flowmeter 10, having the measurement pipe 1 and the transmitting bodies 2 formed to be integral with each other, is fabricated by cutting work, and then, as shown in FIG. 3A, a bar-like heater 14 having an outer diameter almost equal to the inner diameter of the measurement pipe 1 is inserted into the measurement pipe 1 as heating means, and power is supplied to the heater 14 through an electric cable 15, thereby heating and melting the inner peripheral surface 1a of the measurement pipe 1 for a given period. Thereafter, as shown in FIG. 3B, the inner peripheral surface 1a is smoothed by pulling out the heater 14 from the measurement pipe 1 in a heated state, and the measurement pipe 1 is cooled, thus fabricating the measurement pipe 1 having the arithmetic mean roughness of the inner peripheral surface 1a of 0 μm<Ra≦0.2 μm. The surface roughness of the inner peripheral surface 1a of the measurement pipe 1 can be adjusted by controlling temperature conditions or a distance between an outer peripheral surface of the heater 14 and the inner peripheral surface 1a of the measurement pipe 1. It is obvious that, as long as the inner peripheral surface 1a of the measurement pipe 1 is melted by heat, an instrument other than the bar-like heater 14 may be used as the heating means. When using this method, a material for the measurement pipe 1 should be a resin, metal, glass and so on so as to be able to melt the inner peripheral surface 1a of the measurement pipe 1. The measurement pipe 1 having the smooth inner peripheral surface 1a was fabricated by pulling out the heater 14 from the measurement pipe 1 after increasing temperature of the heater 14 to 280 C° and then performing heating for 8 seconds. Output signals from the ultrasonic transducer 3 on the receiving side of the ultrasonic flowmeter 10 under the same conditions were compared before and after smoothing by melting. As a result, a peak-to-peak voltage Vp-p of the output signal from the ultrasonic transducer 3 on the receiving side before smoothing by melting was 42 mV, while the peak-to-peak voltage Vp-p of the output signal from the ultrasonic transducer 3 on the receiving side after smoothing by melting was 170 mV. It was thus confirmed that strength of received signal was enhanced and that an influence of microscopic bubbles was reduced. An effect of improvement in measurement accuracy was also achieved.

The methods described above are merely examples, and a method for smoothing the inner peripheral surface 1a of the measurement pipe 1 is not limited to the methods described above as long as the arithmetic mean roughness Ra of the inner peripheral surface 1a of the measurement pipe 1 can be within the range of 0 μm<Ra≦0.2 μm. For example, after fabricating the measurement pipe 1 by extrusion molding so that the arithmetic mean roughness Ra of the inner peripheral surface 1a is within the range of 0 μm<Ra≦0.2 μm, the pair of transmitting bodies 2 may be formed on the outer side portions of the measurement pipe 1 so as to be integral with each other, by insert molding, while using the fabricated measurement pipe 1 as an insert, thereby fabricating the ultrasonic flowmeter 10 having the measurement pipe 1 and the pair of transmitting bodies 2 formed to be integral with each other.

Next, the operation of the ultrasonic flowmeter 10 will be described.

In the ultrasonic flowmeter 10, when a voltage pulse or a voltage having no frequency component is applied from a converter (not shown) to the ultrasonic transducer 3 located on the upstream side along the fluid flow direction, the ultrasonic transducer 3 generates a vibration in a direction along the thickness (i.e., in a direction of voltage application) and in a diameter direction (i.e., in a direction perpendicular to the direction of the voltage application) of the ultrasonic transducer 3. The end face on the bottom face side, i.e., the axial end face, of the transmitting body 2 is fixedly secured to the axial end face of the ultrasonic transducer 3 and a voltage is applied between both axial end faces of the ultrasonic transducers 3, so that the ultrasonic vibration in the direction along the thickness, which has a large energy of the ultrasonic vibration, is propagated to the end face of the transmitting body 2 on the bottom face side. The ultrasonic vibration thus propagated to the transmitting body 2 is further transmitted to the fluid in the measurement pipe 1 through the transmitting body 2 and the pipe wall of the measurement pipe 1 and is propagated in the fluid inside the measurement pipe 1 while being repeatedly reflected on the outer peripheral surface of the measurement pipe 1. Thereafter, ultrasonic vibration is propagated, through the transmitting body 2 located on the downstream side in opposed relation, to the ultrasonic transducer 3 fixed to the transmitting body 2 located on the downstream side, and is converted into an electric signal, which is outputted to the converter.

When the ultrasonic vibration is transmitted from the upstream ultrasonic transducer 3 to the downstream ultrasonic transducer 3 and received by it, the transmitting and receiving sides are instantaneously switched in the converter, and a voltage pulse or a voltage having no frequency component is applied from the converted to the downstream ultrasonic transducer 3. Then, similarly to the upstream ultrasonic transducer 3, the ultrasonic vibration is generated and propagated to the fluid in the measurement pipe 1 through the transmitting body 2. This ultrasonic vibration is again received by the ultrasonic transducer 3 fixed to the transmitting body located on the upstream side in opposed relation and is then converted into an electric signal, which is outputted to the converter. In the process, the ultrasonic vibration is propagated against the flow of the fluid in the measurement pipe 1. Therefore, the propagation velocity of the ultrasonic vibration in the fluid is lower than when the ultrasonic vibration transmitted from the upstream ultrasonic transducer 3 is received by the downstream ultrasonic transducer 3, and the propagation time is longer.

In the converter, the propagation time of the ultrasonic vibration from the upstream ultrasonic transducer 3 to the downstream ultrasonic transducer 3 and the propagation time of the ultrasonic vibration from the downstream ultrasonic transducer 3 to the upstream ultrasonic transducer 3 are measured, and a flow velocity and a flow rate are computed based on a difference between the propagation times. Thus, highly accurate measurement of a flow rate can be achieved.

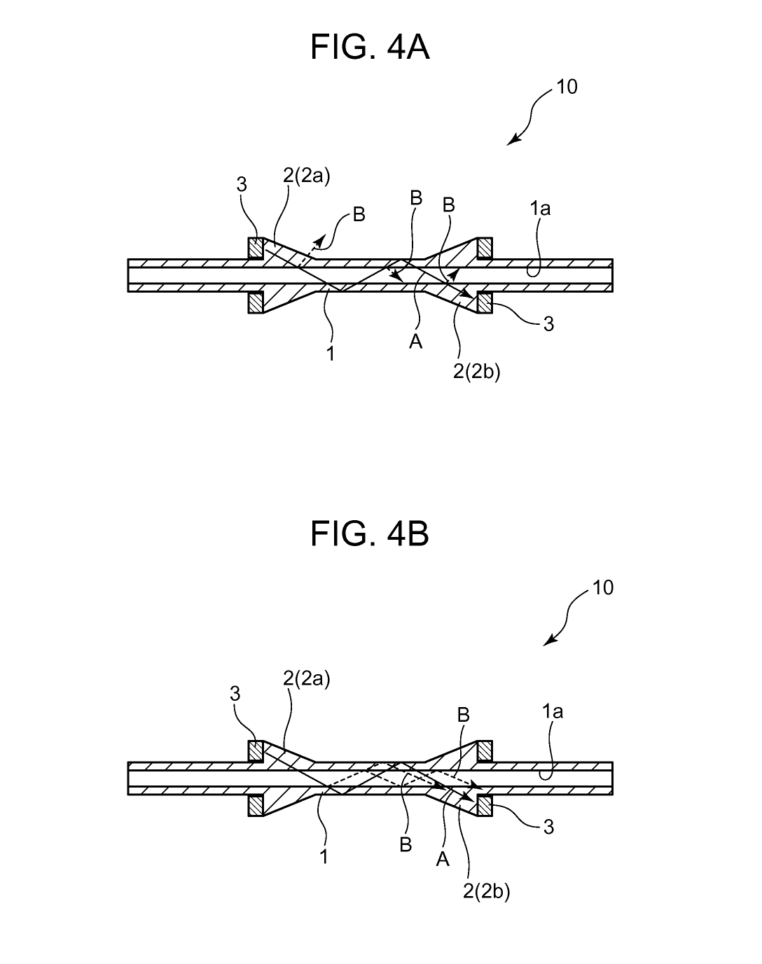

Microscopic bubbles adhered to the inner peripheral surface 1a of the measurement pipe 1 of the ultrasonic flowmeter 10 reflect ultrasonic waves on the surfaces of the microscopic bubbles. As shown by an arrow A in FIG. 4A, the ultrasonic vibration that is not affected by the microscopic bubbles is propagated in the measurement pipe 1 while being repeatedly reflected on the outer peripheral surface of the measurement pipe 1. However, as shown by arrows B in FIG. 4A, when the microscopic bubbles are adhered to the inner peripheral surface 1a of the measurement pipe 1, ultrasonic vibration, which has been propagated from the ultrasonic transducer 3 on the transmitting side to the transmitting body 2 and the measurement pipe 1, is reflected on a boundary between the measurement pipe 1 and the microscopic bubbles, i.e., near the inner peripheral surface 1a of the measurement pipe 1, thereby disturbing propagation of the ultrasonic vibration to the fluid in the measurement pipe 1, or ultrasonic vibration, which is propagated in the fluid in the measurement pipe 1, is reflected on a boundary between the fluid in the measurement pipe 1 and the microscopic bubbles, thereby disturbing entrance of the ultrasonic vibration into the ultrasonic transducer 3 on the receiving side. As a result, an amount of ultrasonic waves that reach the ultrasonic transducer 3 on the receiving side can be reduced, thereby causing a reduction of signal strength. As shown in FIG. 4B, the ultrasonic vibration that is not affected by the microscopic bubbles is propagated inside the measurement pipe 1 while being repeatedly reflected on the outer peripheral surface of the measurement pipe 1 as indicated by an arrow A. On the other hand, as indicated by an arrow B, when the microscopic bubbles are adhered to the inner peripheral surface 1a of the measurement pipe 1, the ultrasonic vibration is reflected on a boundary surface between the microscopic bubbles and the surrounding area thereof, thereby making differences among propagation passages of the ultrasonic vibration and affecting the propagation time. As a result, measurement accuracy can be deteriorated.

In the ultrasonic flowmeter 10 according to the present invention, the inner peripheral surface 1a of the measurement pipe 1 of the ultrasonic flowmeter 10 is smoothed by reducing surface roughness of the inner peripheral surface 1a, thereby restraining microscopic bubbles from being adhered to the inner peripheral surface 1a of the measurement pipe 1. Therefore, it is unlikely that ultrasonic vibration is reflected on the microscopic bubbles and that reduction of signal strength and deterioration of measurement accuracy due to the microscopic bubbles may be restrained.

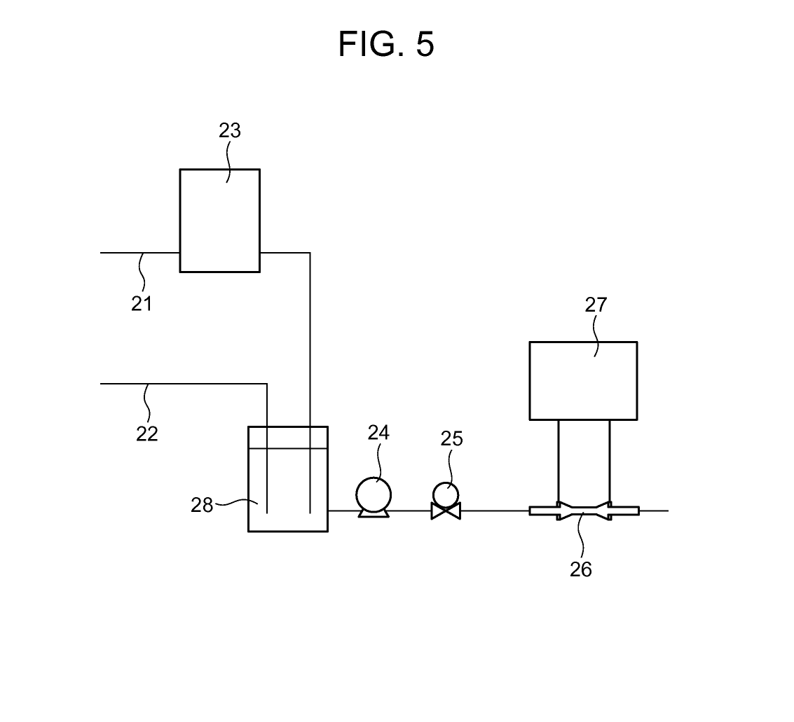

FIG. 5 shows experimental equipment for confirming an influence of adhesion of microscopic bubbles due to surface roughness on measurement accuracy and signal strength. In the experiment, air 22 was supplied into a tank 28 filled with pure water 21 degassed by a degasifier 23, and bubbling was performed for 30 minutes. Thus, pure water containing microscopic bubbles was prepared. While adjusting a flow rate by using a valve 25, the pure water containing the microscopic bubbles was supplied by a pump 24 from the tank 28 to an ultrasonic flowmeter 26, and output signals from the ultrasonic flowmeter 26 (specifically, the ultrasonic transducer on the receiving side thereof) was observed by using an oscilloscope 27.

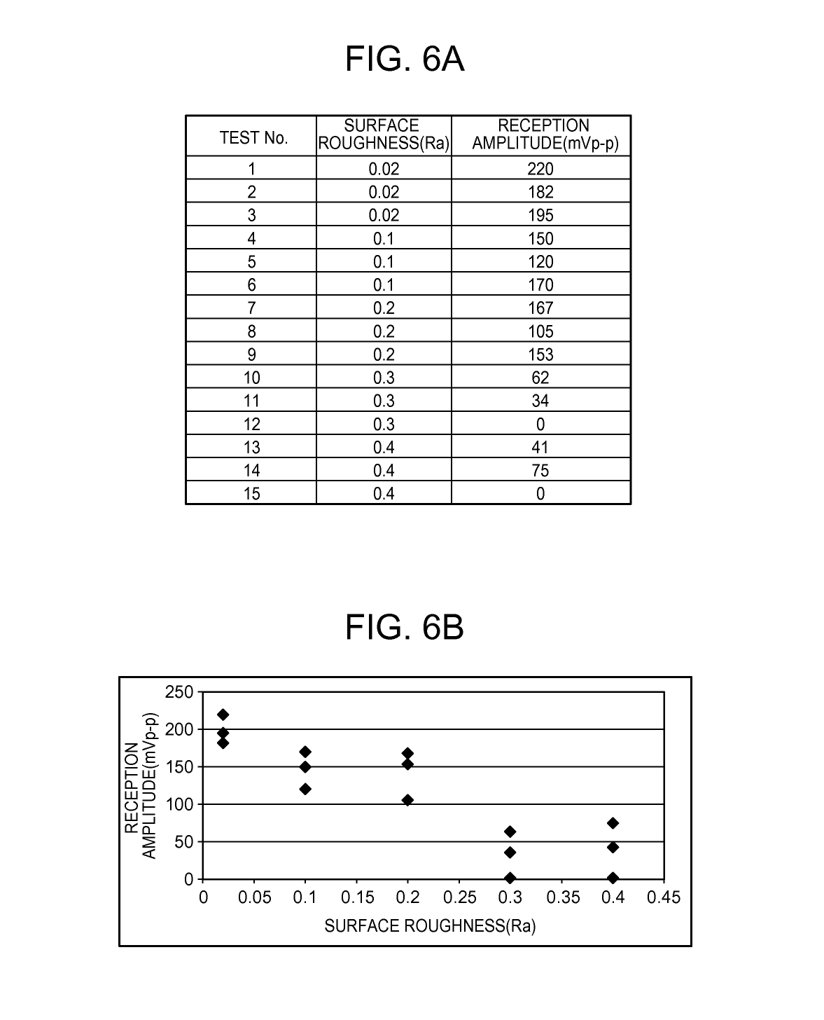

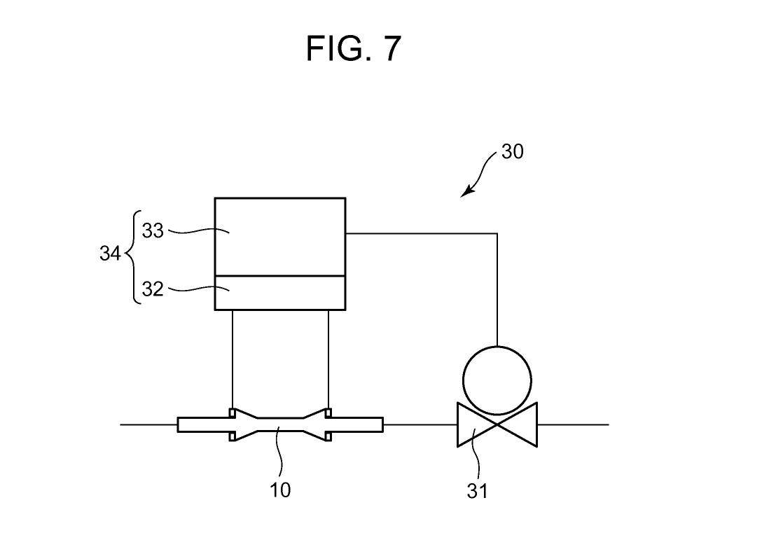

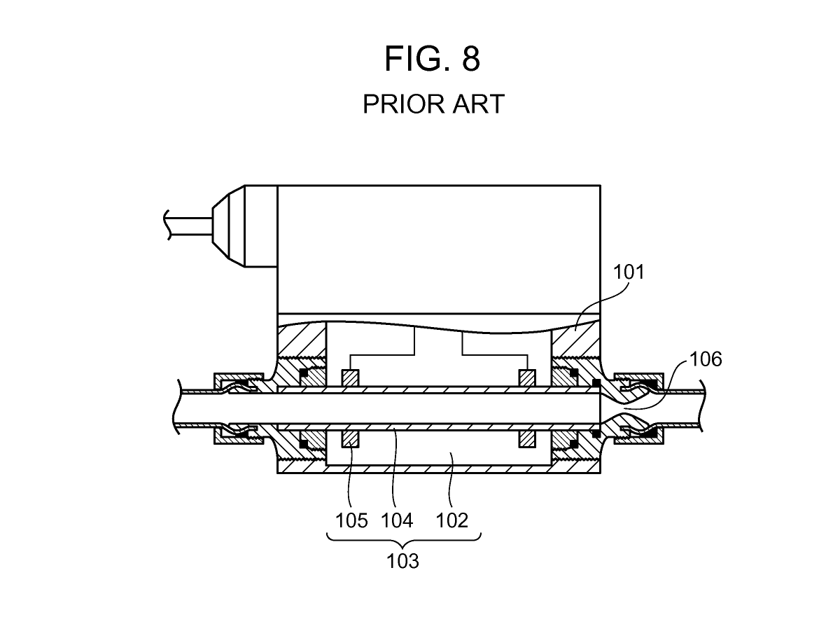

The ultrasonic flowmeter 26 used has the same configuration as the ultrasonic flowmeter 10, and includes a measurement pipe having a length of 40 mm, an outer diameter of 3 mm, and an inner diameter of 2 mm. When a square-wave voltage pulse having a frequency of 600 kHz and an amplitude of ±5 V was applied to the ultrasonic transducer on the transmitting side, a peak-to-peak voltage Vp-p of an output signal from the ultrasonic transducer on the receiving side was measured by using the oscilloscope 27. FIG. 6A is a table showing a relationship between surface roughness of the measurement pipe of the ultrasonic flowmeter 26 and amplitude (peak-to-peak voltage Vp-p) of a signal received by the ultrasonic transducer on the receiving side in the experiment using the ultrasonic flowmeter 26, and FIG. 6B is a graph showing the relationship shown in FIG. 6A. With reference to FIG. 6A and FIG. 6B, it is proved that, as the arithmetic mean roughness Ra of the inner peripheral surface of the measurement pipe is changed, the peak-to-peak voltage Vp-p of an output signal from the ultrasonic transducer on the receiving side in the ultrasonic flowmeter 10 is changed. From FIG. 6A and FIG. 6B, it can be confirmed that in the range of 0 μm<Ra≦0.2 μm, the peak-to-peak voltage Vp-p of the output signal from the ultrasonic transducer on the receiving side is increased significantly, compared to a case of Ra>0.2 μm, and that strength of the signal received by the ultrasonic transducer on the receiving side is enhanced, thereby reducing an influence of the microscopic bubbles. An effect of improvement in measurement accuracy was also achieved.

### EXAMPLES

FIG. 7 shows a fluid controller 30 having used therein the ultrasonic flowmeter 10 according to the present invention.

The fluid controller 30 includes the ultrasonic flowmeter 10, a fluidic element 31 for adjusting a flow rate, a flow velocity, a pressure and so on of a fluid, and an electric component 34 that processes an output signal from the ultrasonic flowmeter 10 and performs control.

For example, an electric-driven or air-driven pinch valve may be used as the fluidic element 31. However, the fluidic element 31 is not limited to the electric-driven or air-driven pinch valve as long as the fluidic element 31 is an instrument for adjusting a flow rate, a flow velocity, a pressure and so on of a fluid.

The electric component 34 includes an amplifier part 32 that amplifies an output signal from the ultrasonic transducer 3 of the ultrasonic flowmeter 10, and a control part 33 that performs control based on the signal amplified by the amplifier part 32, so that the electric component 34 can control the operation of the fluidic element 31 based on a control signal from the control part 33 and perform fluid control.

Since the ultrasonic flowmeter 10 according to the present invention is used in the fluid controller 30, it is possible to measure a flow rate of a fluid with high accuracy, thereby achieving accurate fluid control.

1. An ultrasonic flowmeter comprising a measurement pipe through which a fluid flows, and two ultrasonic transceivers mounted on two transmitting bodies, respectively, said transmitting bodies being provided on outer side portions of the measurement pipe so as to be spaced from each other in an axis direction, said measurement pipe and said two transmitting bodies being formed integrally with each other, said ultrasonic flowmeter determining a flow velocity of the fluid by receiving an ultrasonic vibration transmitted from one of said two ultrasonic transceivers through the fluid in said measurement pipe with the other ultrasonic transceiver, alternately switching between the ultrasonic transceiver on the transmitting side and the ultrasonic transceiver on the receiving side, and measuring the ultrasonic propagation time between said two ultrasonic transceivers,
wherein said measurement pipe has a length, an inner diameter uniform in a length direction, and an arithmetic mean roughness Ra of an inner peripheral surface, said inner diameter being equal to or less than 5 mm, said length of said measurement pipe being equal to or more than 30 mm, and said arithmetic mean roughness Ra satisfying a relation of 0 μm<Ra≦0.2 μm.

2. The ultrasonic flowmeter according to claim 1, wherein said arithmetic mean roughness Ra of the inner peripheral surface of said measurement pipe satisfies a relation of 0 μm<Ra≦0.02 μm.

3. The ultrasonic flowmeter according to claim 1, wherein said measurement pipe and said transmitting bodies are made of a same kind of fluorine resin.

4. The ultrasonic flowmeter according to claim 2, wherein said measurement pipe and said transmitting bodies are made of a same kind of fluorine resin.

5. A fluid control device, comprising the ultrasonic flowmeter according to claim 1, and a control part controlling an instrument in accordance with an output from said ultrasonic flowmeter.
